(19) United States
(12) Patent Application Publication
(10) Pub. No.: US 2004/0196136 A1
(43) Pub. Date: Oct. 7, 2004

(54) Low-inductance resistance device with bi-directional archimedian spiral layout

(76) Inventor: Tai-Her Yang, Dzan-Hwa (TW)

Correspondence Address: RABIN & BERDO, P.C., Suite 500, 1101 14th Street, N.W., Washington, DC, 20005, US

(21) Appl. No.: 10/407,132

(22) Filed: Apr. 7, 2003

(51) Int. Cl. H01C 3/02; H01C 7/00

(52) U.S. Cl. 338/62

(57) ABSTRACT

The low-inductance resistance device with a bi-directional Archimedian spiral layout is to reveal a resistance element with a single-layer or multilayer reverse spiral layout, having such features as winding, in a bi-directional Archimedian spiral or reverse bend layout, coating-like, film-like, ceramic or metallic resistance material round a cylindrical core. In addition, the low-inductance resistance device maybe comprised of a single layer or multiple layers, as appropriate, facilitating the off-set of its magnetic line of force and the reduction in the resistor's inductance, so that it may be applied to high-frequency circuits.

### BACKGROUND OF THE INVENTION

(a) Field of the Invention

The present invention reveals a low-inductance resistance device with a bi-directional Archimedian spiral layout, which may be applied to low-inductance resistors used in high-frequency circuits, and, if designed in a planar or multilayer form, become one of the options for the application of various high-frequency circuits.

(b) Description of the Prior Art:

The traditional method for the production of low-inductance resistance devices involves reversely winding resistance materials, in a two-way manner, round cylindrical cores made from insulation materials or any other kinds of cylindrical cores. However, there are two drawbacks. Firstly, bulkiness. Secondly, a low-inductance resistance device produced in this way cannot be presented in the form of a film and thus it cannot be applied to integrated circuit manufacturing.

### SUMMARY OF THE INVENTION

The low-inductance resistance device with a bi-directional Archimedian spiral layout is to reveal a resistance element with a single-layer or multilayer reverse spiral layout, having such features as winding, in a bi-directional Archimedian spiral or reverse bend layout, coating-like, film-like, ceramic or metallic resistance material round a cylindrical core. In addition, the low-inductance resistance device maybe comprised of a single layer or multiple layers, as appropriate, facilitating the off-set of its magnetic line of force and the reduction in the resistor's inductance, so that it maybe applied to high-frequency circuits.

### BRIEF DESCRIPTION OF THE DRAWINGS

FIG. 1 is a diagram about a preferred embodiment of the present invention wherein the resistors' single-layer, bi-directional Archimedian spiral layout has a square pattern.

FIG. 2 is a diagram about a preferred embodiment of the present invention wherein the resistors' single-layer, bi-directional Archimedian spiral layout has a circular pattern.

FIG. 3 is a diagram about a preferred embodiment of the present invention wherein the resistors' single-layer, bi-directional Archimedian spiral layout has a triangular pattern.

FIG. 4 is a diagram illustrating the two-layer structure of the resistors depicted in FIG. 1.

FIG. 5 is a diagram illustrating the three-layer structure of the resistors depicted in FIG. 1.

FIG. 6 depicts the structure of the equal-phase layout of the resistors that overlap each other with the same shape and the same dimension and in the same position.

FIG. 7 depicts the structure of the antiphase layout of the resistors that overlap each other with the same shape and the same dimension and in the same position.

FIG. 8 is a diagram about the preferred embodiment of the present invention wherein the resistors are arranged in such a way that their electrical phase-angle difference is 90.

FIG. 9 is a diagram about a preferred embodiment of the present invention wherein the resistor has a single-surface, single-bend, single-layer layout.

FIG. 10 is a diagram about a preferred embodiment of the present invention wherein the resistor has a double-surface, single-bend, single-layer layout.

FIG. 11 is a diagram about a preferred embodiment of the present invention wherein the resistors have a multilayer, multiple-bend layout.

FIG. 12 is a diagram about a preferred embodiment of the present invention, wherein both sides of the resistor have a flexible insulation carrier, and the resistor, together with the insulation carriers, winds in a concentric manner.

### DETAILED DESCRIPTION OF THE PREFERRED EMBODIMENTS

The low-inductance resistance device with a bi-directional Archimedian spiral layout is produced by winding around a cylindrical core, in a bi-directional Archimedian spiral manner, coating-like, film-like, ceramic or metallic resistance material including common resistance materials and resistance materials with positive temperature coefficients (PTC) or negative temperature coefficients (NTC). In addition, the low-inductance resistance device maybe comprised of a single layer or multiple layers, as appropriate, facilitating the off-set of its magnetic line of force and greatly reducing resistor inductance.

As regards the low-inductance resistance device with a bi-directional Archimedian spiral layout, its bi-directional Archimedian spiral layout may appear in a square, circular or triangular pattern or any other geometric pattern.

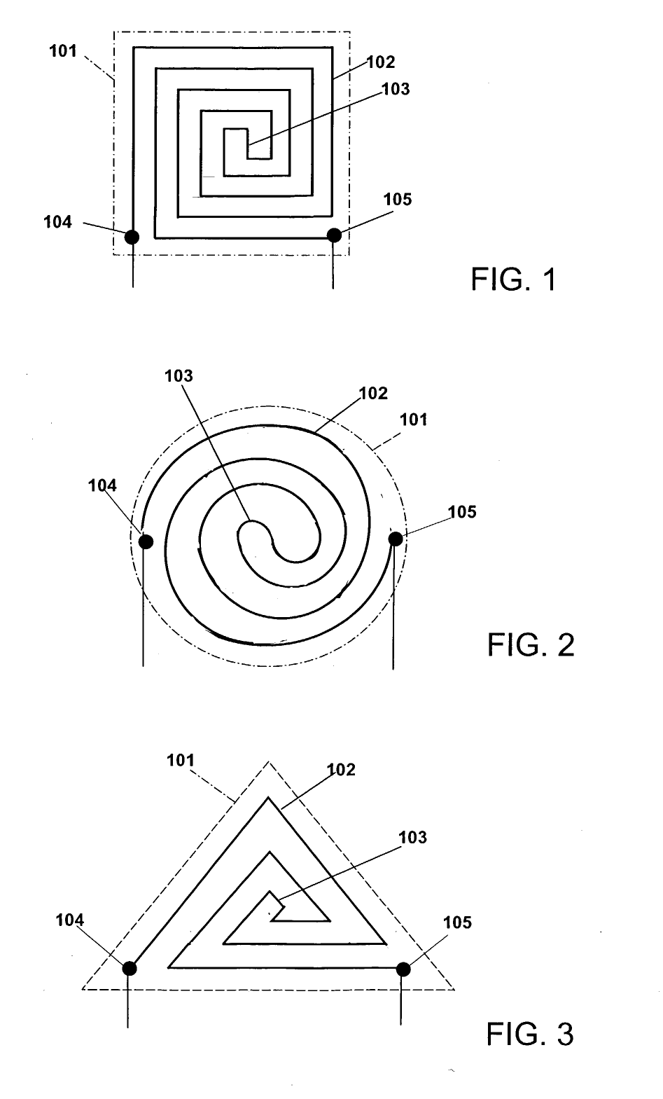

FIG. 1 is a diagram about a preferred embodiment of the present invention wherein the resistor's single-layer, bi-directional Archimedian spiral layout has a square pattern.

FIG. 2 is a diagram about a preferred embodiment of the present invention wherein the resistor's single-layer, bi-directional Archimedian spiral layout has a circular pattern.

FIG. 3 is a diagram about a preferred embodiment of the present invention wherein the resistor's single-layer, bi-directional Archimedian spiral layout has a triangular pattern.

The preferred embodiment of the present invention as illustrated in FIGS. 1, 2 and 3 is comprised of the following:

the insulation carrier 101 is an insulation film or substrate made from soft, flexible or hard insulation materials or whatever structures that enable the resistor 102 to have a bi-directional Archimedian spiral layout;

the resistor 102 that has a bi-directional Archimedian spiral layout is designed in such away that coating-like, film-like, ceramic or metallic resistance material is wound round a cylindrical core, following a square, circular or triangular path or a path in any other geometrical pattern, and that it is covered with an insulation carrier 101, and that in its path there are a midway, reverse kickback point 103, as well as a starting point 104 and an ending point 105, both of which serve as an interface for the external connection of the above-mentioned resistor with a bi-directional Archimedian spiral layout;

the bi-directional Archimedian spiral layout of the resistor facilitates the off-set of the resistor's magnetic line of force and thus it reduces the resistor's inductance.

The low-inductance resistance device with a bi-directional Archimedian spiral layout may be comprised of more than one layer, in other words, it may have one layer, two layers, three layers or more than three layers. The explanation of a structure with an even number (2, for example) of layers or an odd number (3, for example) of layers is as follows:

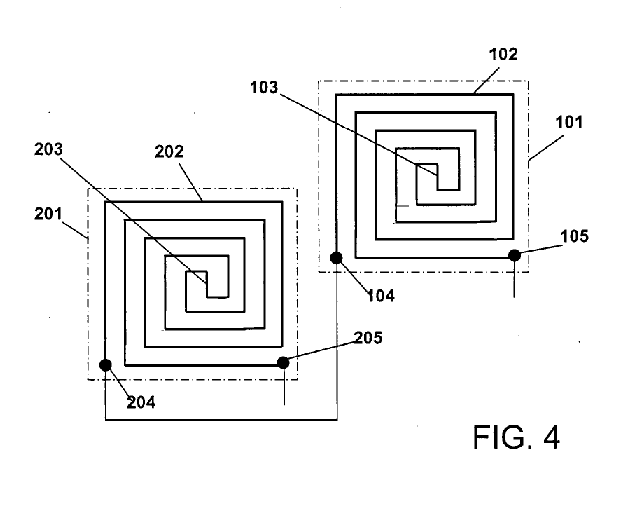

FIG. 4 is a diagram illustrating the two-layer structure of the resistors depicted in FIG. 1.

The preferred embodiment depicted in FIG. 4 comprises the following:

the insulation carriers 101 and 201 are insulation film or substrate made from soft, flexible or hard insulation materials or whatever structures that enable the resistors 102 and 202 to have bi-directional Archimedian spiral layouts;

the resistors 102 and 202 that have bi-directional Archimedian spiral layouts are designed in such a way that coating-like, film-like, ceramic or metallic resistance material is wound round a cylindrical core, following a square, circular or triangular path or a path in any other geometrical pattern, and that they are covered with insulation carriers 101 and 201, and that the starting point 104 of the first-layer resistor 102 with a bi-directional Archimedian spiral layout is connected to the starting point 204 of the second-layer resistor 202 with a bi-directional Archimedian spiral layout, and that in the path of the first-layer resistor there is a midway, reverse kickback point 103, whereas in the path of the second-layer resistor there is also a midway, reverse kickback point 203, and that both the ending point 105 of the path of the first-layer resistor and the ending point 205 of the path of the second-layer resistor function as the interface for external connection.

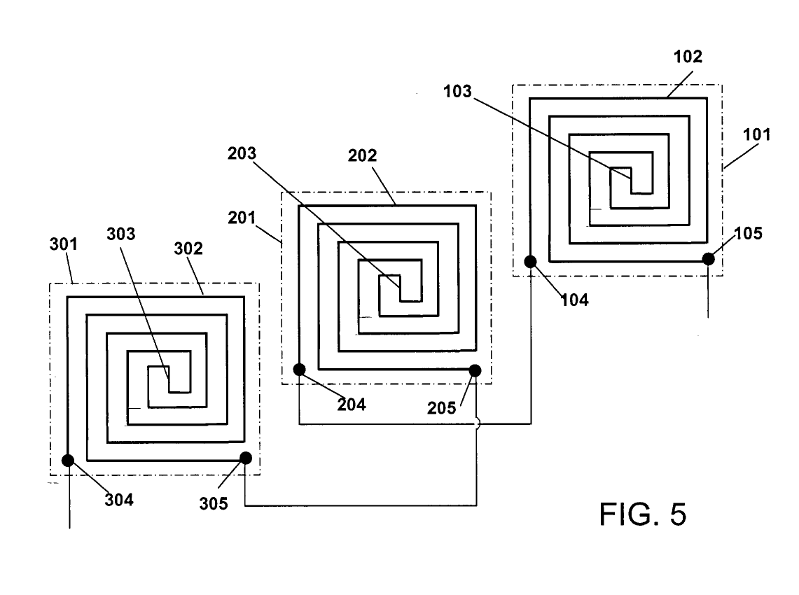

FIG. 5 is a diagram illustrating the three-layer structure of the resistors depicted in FIG. 1.

The preferred embodiment depicted in FIG. 5 comprises the following:

the insulation carriers 101, 201 and 301 are insulation film or substrate made from soft, flexible or hard insulation materials or whatever structures that enable the resistors 102, 202 and 302 to have bi-directional Archimedian spiral layouts;

the resistors 102, 202 and 302 that have bi-directional Archimedian spiral layouts are designed in such a way that coating-like, film-like, ceramic or metallic resistance material is wound round a cylindrical core, following a square, circular or triangular path or a path in any other geometrical pattern, and that they are covered with insulation carriers 101, 201 and 301, and that the starting point 104 of the first-layer resistor 102 with a bi-directional Archimedian spiral layout is connected to the starting point 204 of the second-layer resistor 202 with a bi-directional Archimedian spiral layout, and that the ending point 205 of the second-layer resistor 202 with a bi-directional Archimedian spiral layout is connected to the ending point 305 of the third-layer resistor 302 with a bi-directional Archimedian spiral layout, and that in the paths of the first-layer, the second-layer and the third-layer resistors there are midway, reverse kickback points 103, 203 and 303, respectively, and that both the ending point 105 of the path of the first-layer resistor 102 and the starting point 304 of the path of the third-layer resistor 302 function as the interface for external connection.

As regards the multilayer structure depicted in FIGS. 4 and 5, the feasible relation between the resistors in the multilayer, bi-directional Archimedian spiral layout is as follows:

(1) similar or dissimilar shapes

(2) similar or dissimilar dimensions

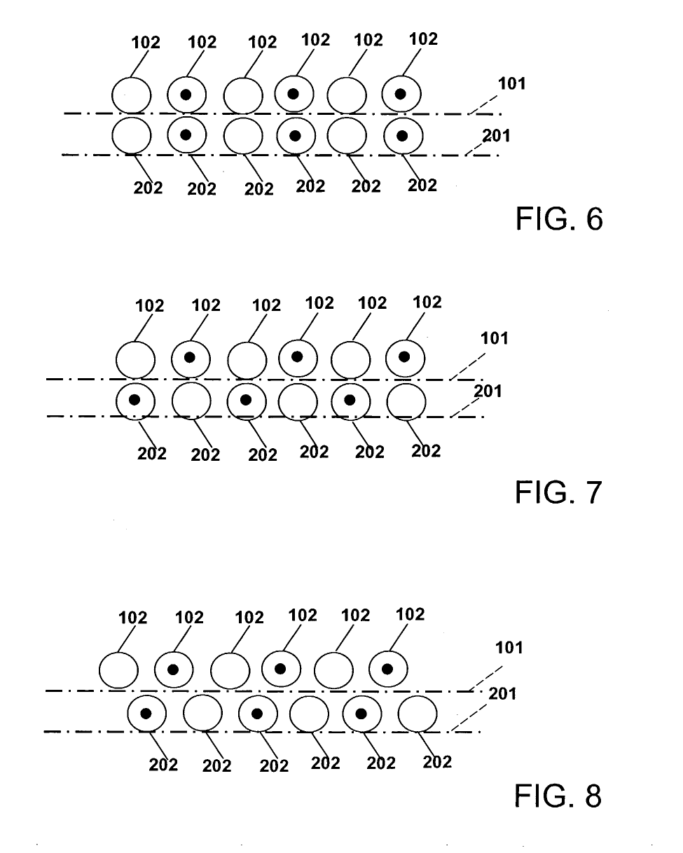

(3) similar shapes, similar dimensions and an equal-phase layout characterized by completely same-position overlap, as shown in FIG. 6

(4) similar shapes, similar dimensions and an antiphase layout characterized by completely same-position overlap, as shown in FIG. 7

(5) similar shapes and similar dimensions; an out-of-phase layout characterized by completely same-position overlap and an electrical phase-angle difference of 90 as shown in FIG. 8, while the other electrical phase-angle differences are worked out by analogy;

(6) A resistance element with a multilayer, bi-directional Archimedian spiral layout may be installed on both sides of an insulation carrier. Layers of insulation carrier may be installed with resistance elements that have bi-directional Archimedian spiral layouts, respectively, and then overlap to become a multilayer structure. Allow gaps between individual layers for ventilation and cooling or make the joints or the packages seamless, for structural options.

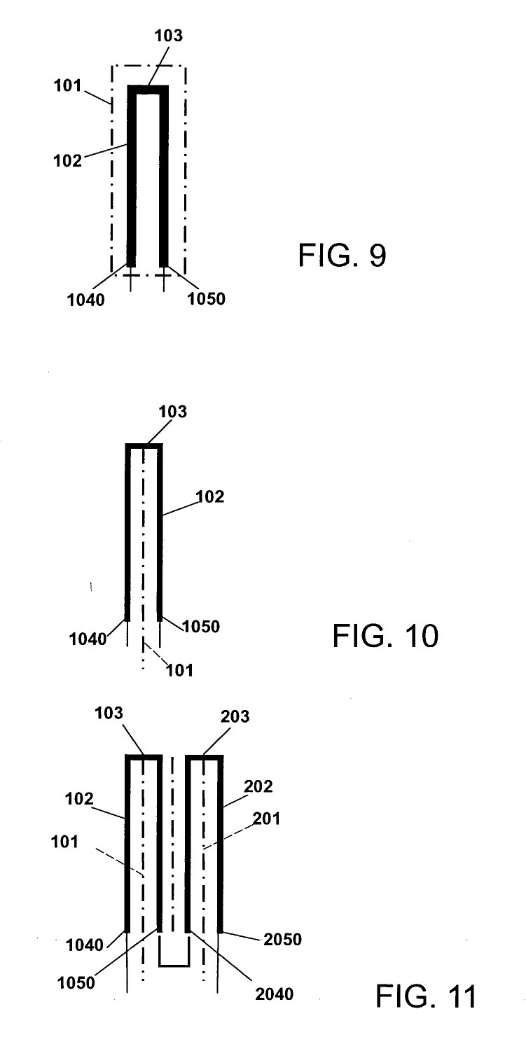

FIG. 9 is a diagram about a preferred embodiment of the present invention wherein the resistor has a single-surface, single-bend, single-layer layout. Wherein, the preferred embodiment comprises an insulation carrier 101, a resistor made from coating-like, film-like, ceramic or metallic resistance material and a connective interface. The key features of the preferred embodiment are as follows. The resistor 102 is installed on one side of the insulation carrier in a U-shaped pattern. The resistor 102 is divided into two bar-like parts connected with each other by the kickback point 103 which is, actually, a U-shaped bend. The two bar-like parts of the resistor 102 lie close to each other, leading to the off-set of their magnetic line of force and the reduction in their inductance. The pins 1040 and 1050 of the two bar-like parts of the resistor 102 function as an interface for external connection.

FIG. 10 is a diagram about a preferred embodiment of the present invention wherein the resistor has a double-surface, single-bend, single-layer layout. Wherein, the preferred embodiment comprises an insulation carrier 101, a resistor made from coating-like, film-like, ceramic or metallic resistance material and a connective interface. The key features of the preferred embodiment are as follows. The resistor 102 is installed on both sides of the single-layer insulation carrier 101 in a U-shaped pattern. The resistor 102 is divided into two bar-like parts connected, in series, with each other by the kickback point 103. The pins 1040 and 1050 of the two bar-like parts of the resistor 102 function as an interface for external connection.

FIG. 11 is a diagram about a preferred embodiment of the present invention wherein the resistors have a multilayer, multiple-bend layout. Wherein, the preferred embodiment comprises a multilayer insulation carrier, a resistor made from coating-like, film-like, ceramic or metallic resistance material and a connective interface. The key features of the preferred embodiment are as follows. The resistor 102 is installed on both sides of the insulation carrier 101 in a U-shaped pattern. The resistor 102 is divided into two bar-like parts connected, in series, with each other by the kickback point 103. The second-layer resistor 202 is installed on both sides of the insulation carrier 201 in a U-shaped pattern. The resistor 202 is divided into two bar-like parts connected, in series, with each other by the kickback point 203. Insulators 106 are installed inbetween the resistors overlapping each other in the multilayer structure. When overlapped, the neighboring bar-like parts of the resistors have pins 1050 and 2040 connected to each other. The pins 1040 and 2050 of the resistors function as an interface for external connection.

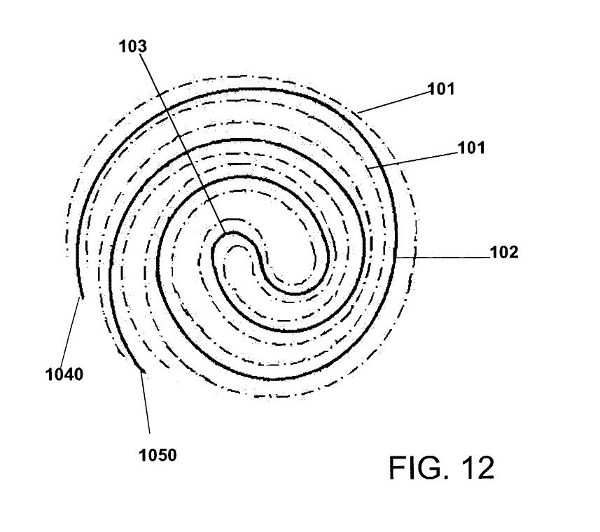

FIG. 12 is a diagram about a preferred embodiment of the present invention, wherein both sides of the resistor have a flexible insulation carrier, and the resistor, together with the insulation carriers, winds in a concentric manner. The flexible insulation carrier 101 is installed on both sides of the strip-like or film-like, flexible resistor 102, while the flexible resistor 102 follows a path of bi-directional Archimedian spiral inbetween the flexible insulation carrier 101. The kickback point 103 of the flexible resistor 102 is the core of the Archimedian spiral layout. The two outer most pins 1040 and 1050 of the flexible resistor 102 function as an interface for external connection.

In short, the low-inductance resistance device with a bi-directional Archimedian spiral layout is the first of its kind wherein resistance materials are arranged in a bi-directional Archimedian spiral, making planar or multilayer, high-frequency, low-inductance resistors feasible. It embodies a new notion, and its function is definite. It is hereby petitioned that the application for taking out a patent on the prevent invention be approved.

1. A low-inductance resistance device with a bi-directional Archimedian spiral layout, wherein the resistor has a single-layer or multilayer, reverse spiral layout, and coating-like, film-like, ceramic or metallic resistance material is wound round a cylindrical core in a bi-directional Archimedian spiral or reverse bend layout. In addition, the low-inductance resistance device can be comprised of a single layer or multiple layers, as appropriate, facilitating the off-set of its magnetic line of force and the reduction in the resistor's inductance, so that it may be applied to high-frequency circuits. The low-inductance resistance device with a bi-directional Archimedian spiral layout is produced by winding around a cylindrical core, in a bi-directional Archimedian spiral manner, coating-like, film-like, ceramic or metallic resistance material including common resistance materials and resistance materials with positive temperature coefficients (PTC) or negative temperature coefficients (NTC). In addition, the low-inductance resistance device may be comprised of a single layer or multiple layers, as appropriate, facilitating the off-set of its magnetic line of force and greatly reducing resistor inductance. It comprises the following:
the insulation carrier 101 is an insulation film or substrate made from soft, flexible or hard insulation materials or whatever structures that enable the resistor 102 to have a bi-directional Archimedian spiral layout;
the resistor 102 that has a bi-directional Archimedian spiral layout is designed in such a way that coating-like, film-like, ceramic or metallic resistance material is wound round a cylindrical core, following a square, circular or triangular path or a path in any other geometrical pattern, and that it is covered with an insulation carrier 101, and that in its path there are a midway, reverse kickback point 103, as well as a starting point 104 and an ending point 105, both of which serve as an interface for the external connection of the above-mentioned resistor with a bi-directional Archimedian spiral layout, the bi-directional Archimedian spiral layout of the resistor facilitates the off-set of the resistor's magnetic line of force and thus it reduces the resistor's inductance.

2. The low-inductance resistance device with a bi-directional Archimedian spiral layout as claimed in claim 1, wherein, it can be a multilayer structure, including a two-layer structure, a three-layer structure or a structure with more than three layers; the two-layer structure (representing a structure with an even number of layers) comprises the followings:
the insulation carriers 101 and 201 are insulation film or substrate made from soft, flexible or hard insulation materials or whatever structures that enable the resistors 102 and 202 to have bi-directional Archimedian spiral layouts;
the resistors 102 and 202 that have bi-directional Archimedian spiral layouts are designed in such a way that coating-like, film-like, ceramic or metallic resistance material is wound round a cylindrical core, following a square, circular or triangular path or a path in any other geometrical pattern, and that they are covered with insulation carriers 101 and 201, and that the starting point 104 of the first-layer resistor 102 with a bi-directional Archimedian spiral layout is connected to the starting point 204 of the second-layer resistor 202 with a bi-directional Archimedian spiral layout, and that in the path of the first-layer resistor there is a midway, reverse kickback point 103, whereas in the path of the second-layer resistor there is also a midway, reverse kickback point 203, and that both the ending point 105 of the path of the first-layer resistor and the ending point 205 of the path of the second-layer resistor function as the interface for external connection.

3. The low-inductance resistance device with a bi-directional Archimedian spiral layout as claimed in claim 1, wherein, the three-layer structure (representing a structure with an even number of layers) comprises the followings:
the insulation carriers 101, 201 and 301 are insulation film or substrate made from soft, flexible or hard insulation materials or whatever structures that enable the resistors 102, 202 and 302 to have bi-directional Archimedian spiral layouts;
the resistors 102,202 and 302 that have bi-directional Archimedian spiral layouts are designed in such a way that coating-like, film-like, ceramic or metallic resistance material is wound round a cylindrical core, following a square, circular or triangular path or a path in any other geometrical pattern, and that they are covered with insulation carriers 101, 201 and 301, and that the starting point 104 of the first-layer resistor 102 with a bi-directional Archimedian spiral layout is connected to the starting point 204 of the second-layer resistor 202 with a bi-directional Archimedian spiral layout, and that the ending point 205 of the second-layer resistor 202 with a bi-directional Archimedian spiral layout is connected to the ending point 305 of the third-layer resistor 302 with a bi-directional Archimedian spiral layout, and that in the paths of the first-layer, the second-layer and the third-layer resistors there are midway, reverse kickback points 103, 203 and 303, respectively, and that both the ending point 105 of the path of the first-layer resistor 102 and the starting point 304 of the path of the third-layer resistor 302 function as the interface for external connection.

4. The low-inductance resistance device wit a bi-directional Archimedian spiral layout as claimed in claim 1, wherein, as regards its multilayer structure, the feasible relation between the resistors in the multilayer, bi-directional Archimedian spiral layout is as follows. The relation between the overlapping positions of the resistors lying on the bi-directional Archimedian spiral layout are similar shapes versus dissimilar shapes, similar dimensions versus dissimilar dimensions, or similar shapes, similar dimensions and an equal-phase layout with completely same-position overlap, or similar shapes, similar dimensions and an antiphase layout with completely same-position overlap, or similar shapes, similar dimensions and an out-of-phase layout with completely same-position overlap.

5. The low-inductance resistance device with a bi-directional Archimedian spiral layout as claimed in claim 1, wherein, as regards its multilayer structure, the feasible relation between the resistors in the multilayer, bi-directional Archimedian spiral layout is as follows. A resistance element with a multilayer, bi-directional Archimedian spiral layout may be installed on both sides of an insulation carrier. Layers of insulation carrier maybe installed with resistance elements that have bi-directional Archimedian spiral layouts, respectively, and then overlap to become a multilayer structure. Allow gaps between individual layers for ventilation and cooling or make the joints or the packages seamless, for structural options.

6. The low-inductance resistance device with a bi-directional Archimedian spiral layout as claimed in claim 1, wherein, its structure can have a single-surface, single-bend, single-layer layout. Wherein, the structure comprises an insulation carrier 101, a resistor made from coating-like, film-like, ceramic or metallic resistance material and a connective interface. The key features of the structure are as follows. The resistor 102 is installed on one side of the insulation carrier in a U-shaped pattern. The resistor 102 is divided into two bar-like parts connected with each other by the kickback point 103 which is, actually, a U-shaped bend. The two bar-like parts of the resistor 102 lie close to each other, leading to the off-set of their magnetic line of force and the reduction in their inductance. The pins 1040 and 1050 of the two bar-like parts of the resistor 102 function as an interface for external connection.

7. The low-inductance resistance device with a bi-directional Archimedian spiral layout as claimed in claim 1, wherein, its structure can have a double-surface, single-bend, single-layer layout. Wherein, the structure comprises an insulation carrier 101, a resistor made from coating-like, film-like, ceramic or metallic resistance material and a connective interface. The key features of the structure are as follows. The resistor 102 is installed on both sides of the single-layer insulation carrier 101 in a U-shaped pattern. The resistor 102 is divided into two bar-like parts connected, in series, with each other by the kickback point 103. The pins 1040 and 1050 of the two bar-like parts of the resistor 102 function as an interface for external connection.

8. The low-inductance resistance device with a bi-directional Archimedian spiral layout as claimed in claim 1, wherein, its structure can have a multilayer, multiple-bend layout. Wherein, the structure comprises a multilayer insulation carrier, a resistor made from coating-like, film-like, ceramic or metallic resistance material and a connective interface. The key features of the structure are as follows. The resistor 102 is installed on both sides of the insulation carrier 101 in a U-shaped pattern. The resistor 102 is divided into two bar-like parts connected, in series, with each other by the kickback point 103. The second-layer resistor 202 is installed on both sides of the insulation carrier 201 in a U-shaped pattern. The resistor 202 is divided into two bar-like parts connected, in series, with each other by the kickback point 203. Insulators 106 are installed in between the resistors overlapping each other in the multilayer structure. When overlapped, the neighboring bar-like parts of the resistors have pins 1050 and 2040 connected to each other. The pins 1040 and 2050 of the resistors function as an interface for external connection.

9. The low-inductance resistance device with a bi-directional Archimedian spiral layout as claimed in claim 1, wherein, both sides of the resistor have a flexible insulation carrier, and the resistor, together with the insulation carriers, winds in a concentric manner. The flexible insulation carrier 101 is installed on both sides of the strip-like or film-like, flexible resistor 102, while the flexible resistor 102 follows a path of bi-directional Archimedian spiral in between the flexible insulation carrier 101. The kickback point 103 of the flexible resistor 102 is the core of the Archimedian spiral layout. The two outermost pins 1040 and 1050 of the flexible resistor 102 function as an interface for external connection.
